(19) United States
(12) Patent Application Publication
(10) Pub. No.: US 2021/0387107 A1
(43) Pub. Date: Dec. 16, 2021

(54) DESALINATION SYSTEM BASED ON THE FORMATION OF DROPLETS

(71) Applicants: DANIEL LISS, SILVER SPRING, MD (US); AARON LISS, SILVER SPRING, MD (US)

(72) Inventors: DANIEL LISS, SILVER SPRING, MD (US); AARON LISS, SILVER SPRING, MD (US)

(21) Appl. No.: 16/901,401

(22) Filed: Jun. 15, 2020

(51) Int. Cl. B01D 1/16; B01D 1/06; B01D 1/14; B01D 5/00; C02F 1/12; C02F 1/38; B01D 21/26

(52) U.S. Cl. CPC B01D 1/16; B01D 1/06; B01D 1/14; C02F 2101/12; C02F 1/12; C02F 1/38; B01D 21/267; B01D 5/006

(57) ABSTRACT

The invention relates to desalination systems for separating water from solids and/or undesirable solutes such as salt (sodium chloride). In particular, the invention relates to a desalination system for producing potable water. In a preferred embodiment, the invention produces potable water from salt water such as naturally occurring salt water. The desalination system uses droplets of salt water suspended in an air stream to evaporate into water vapor and particles of salt to be separated using a commercially available cyclone separator. The water vapor is thereafter condensed into potable water.

### BACKGROUND OF THE INVENTION

### Field of the Invention

The invention relates to desalination systems for separating water from solids and/or undesirable solutes such as salt (sodium chloride). In particular, the invention relates to a desalination system for producing potable water. In a preferred embodiment, the invention produces potable water from salt water such as naturally occurring salt water.

### 2. Background Art

The worldwide availability of natural salt water has motivated scientists to develop systems for the desalination of salt water to produce potable water for countries and regions of the world with limited natural supplies of naturally available potable water. About 1% of the world's population is dependent on desalinated water to meet daily needs today, and it is believed that about 14% of the world's population will encounter water scarcity by 2025. The country of Kuwait relies on desalination systems for almost all of its potable water. India also relies greatly on desalination systems. Desalination systems for producing potable water are important for the survival of many people in the world today.

Even in the U.S., there are regions in need of potable water from desalination because naturally available water is insufficient to meet demands. The Tampa Bay area in Florida relies on desalination for about 10% of its potable water. California, Texas and even North Dakota each have many desalination plants.

There are many known types of systems for desalinating water to obtain potable water. The leading issues with known desalination systems are the economic costs as compared to importing potable water, and the effectiveness of producing potable water. That is, most of the salt might be removed from the salt water, but the resulting water is still not potable, and additional processing is necessary to obtain potable water. The following briefly described many of the known systems for desalination.

### Solar Distillation

Solar distillation mimics the natural water cycle, in which the sun heats the salt water to increase the rate of evaporation. After evaporation, the water vapor is condensed onto a cool surface, and collected. Solar distillation is probably the oldest desalination system known. Generally, there are two types of solar distillation systems in use today. One type of solar distillation system uses photovoltaic cells which converts solar energy to electrical energy to power the distillation process to produce potable water. The other type of solar distillation system utilizes the solar energy directly and is referred to in the literature as solar thermal powered distillation.

### Vacuum Distillation

In a vacuum distillation system, atmospheric pressure above the salt water is reduced to increase the rate of evaporation at the lower temperatures. One of the advantages of this system is that “waste” heat from other operations can be used to heat and evaporate the water, thereby making the cost of operating the system more manageable.

### Multi-Stage Flash Distillation

In the multi-stage flash distillation system, salt water is evaporated and separated from the salt in the sea water through multi-stage flash distillation, which is a series of flash evaporations. Each subsequent flash evaporation steps utilizes energy released from the condensation of the water vapor from the previous step. One of the goals of this distillation system is to minimize the operating costs for desalination.

### Multiple-Effect Distillation

A multiple-effect distillation (MED) system works through a series of steps called “effects” in the industry. Incoming water is sprayed onto heated pipes to generate steam. The steam is then used to heat the next batch of incoming salt water. To increase efficiency, “waste” heat can be used from unrelated processes. For example, steam used to heat the sea water can be taken from nearby power plants. Although this method is generally thermodynamically efficient among methods powered by heat, a few limitations still exist such as a maximum temperature and a maximum number of steps available.

### Vapor-Compression Distillation

A vapor-compression evaporation system involves using either a mechanical compressor or a jet stream to compress the vapor present above the salt water. The compressed vapor is then used to provide the heat needed for the evaporation of the rest of the salt water. This system requires considerable power so its use is usually limited to small scale operations.

### Reverse Osmosis

The leading process for desalination systems in terms of installed capacity and yearly growth is the reverse osmosis (RO) systems. The RO membrane systems use semi-permeable membranes and applied pressure (on the membrane feed side) to induce water permeation through the membrane while rejecting salts. Reverse osmosis plant membrane systems typically use less energy than many other desalination systems relying on thermal energy. Energy cost for RO membrane systems depends on water salinity, processing plant size, and the specific processing type. At the present, the cost of seawater desalination systems is expected to decrease as technology improves.

One of the significant drawbacks of the RO membrane systems is the high cost of maintenance for cleaning and replacing the semi-permeable membranes. Another significant drawback is that additional desalination is required after the RO membrane system because the resulting water is still not potable due to the residual salt in the water.

### Freeze-Thaw

The freeze-thaw desalination system uses freezing to separate fresh water from salt water. This process relies on seasonal changes for economical savings. Salt water is sprayed during freezing conditions into a container where an ice-pile build up can occur. When seasonal conditions change to a warm season, naturally desalinated melting water is recovered.

A different freeze-thaw system, not weather dependent, was invented by Alexander Zarchin, and relies on freezing seawater in a vacuum. Under vacuum conditions, the ice desalinates when melted. Water from melted ice is diverted and collected.

### Electro-Dialysis Membrane

The electro-dialysis system utilizes an electric potential to move the salt in the water in response to pairs of charged membranes, to trap salt in alternating channels.

### Membrane Distillation

The membrane distillation system uses a temperature difference across a membrane to evaporate vapor from salt water and thereafter, inducing a condensation of water vapor on the colder side.

### Wave-Powered Desalination

CETO is a wave power technology that desalinates seawater using submerged buoys.

### Additional Known Desalination Systems

A desalination system utilizing droplets is disclosed in U.S. Pat. No. 6,699,369 (“'369 patent”). The system disclosed in the '369 patent includes a nozzle for salt water under high pressure to form a “fog” of salt water in the form of droplets having diameters of about 100 microns or less. A horizontal conduit directs the salt water “fog” into a heated air stream to allow the droplets of salt water an opportunity evaporate and to separate into water vapor and salt crystals. A filter positioned in the path of the water vapor and salt crystals filters the salt crystals from the air stream; and, thereafter, a system for condensing the water vapor to liquid water produces water relatively free of salt.

The '369 patent states that the droplets will evaporate over a distance of a few feet along the horizontal path if the humidity is kept low and the air temperature is elevated. The stream is moving at about 102 ft. per minute or about 1.7 ft. per second. The '369 patent fails to explain how the humidity of the air stream can be kept low if the air stream is carrying a “fog” of droplets evaporating. This appears to be a contradiction because the evaporation of the droplets must increase the humidity. In addition, the '369 patent is urging that the droplets evaporate in a few seconds, but no scientific reasoning is provided to support this critical event.

A scientific article published more than ten years after the '369 patent shows that the assertion in the '369 patent that the evaporation of droplets occurs in seconds is scientifically wrong. The article is entitled, “Small Droplets Are A Surprise: They Disappear More Slowly Than they “Should” dated Oct. 26, 2017 from the Institute of Physical Chemistry of the Polish Academy of Science. It is shown in the article that the prior art calculations for the evaporation of very small droplets in the micro- and nanometer range are substantially wrong because the evaporation occurs much more slowly than predicted by models used.

The issue of evaporation of droplets is discussed in detail in the recent book, “Droplet Interactions and Spray Processes” by Grazia Lamanna et al. published 2020.

This is important for any desalination system utilizing droplets because, regardless the initial sizes of a droplets, droplets eventually diminish in size and pass through a micro- and nanometer size.

Generally, one might expect that as the droplets become smaller in size, the surface area increases, and the increase in surface area would enhance the rate of evaporation. The article dated 2017 explains that the dynamics are different from the prior art understanding.

Part of the detailed explanation for the unexpected reduced rate of evaporation of tiny droplets is that when a gas molecule approaches a liquid surface at a distance of several dozen mean free paths; the gas molecules virtually stop colliding with other molecules in its environment. As a result, the usual description of evaporation using thermodynamics is no longer adequate to explain the evaporation process for droplets. The actual time for a tiny droplet to evaporate is much longer than the prior art estimates. Thus, if the '369 patent discloses an operating system, the system does not operate according to the description in the '369 patent.

Another problem with the '369 patented system is that the droplets are moving with the air stream, rather than having the air stream move past the droplets. As water evaporates, the water molecules tend to linger near the surface of the droplet. This phenomenon is well known with respect to hot soup. It is commonly known that hot soup can be cooled by blowing across the soup. Blowing across the soup moves the insulating layer of molecules near the soup away from the surface of the soup, thereby allowing more molecules to leave the surface and cool the soup. The '369 patent fails to take advantage of an elementary concept leading to better evaporation.

Thus, there is a serious question as to whether a system according to the '369 patent would operate with the parameters set forth in the patent to produce desalinated water.

The challenge today remains to provide an efficient desalination system which is economically suited for continuous production of potable water from salt water for humans, animals, and plants.

The present invention presents an entirely new system for the desalination of salt water to create an economical system suitable for worldwide use.

### 3. Technology Related to the Invention

The invention includes the creation of droplets of water suitable for desalination such as salt water. For convenience, the invention will be described for use with salt water, but other water such as brackish water may be suitable for the process. The creation of the droplets can be accomplished using pneumatic, or non-pneumatic nozzles. A pneumatic nozzle system uses compressed air with the salt water to create droplets and require more energy to produce the droplets. A non-pneumatic nozzle system uses high pressure directly on the salt water to push the salt water through the non-pneumatic nozzle to create droplets. From an economic point of view, it appears that a non-pneumatic nozzle may be preferable; however, the invention does not preclude the use of pneumatic nozzles.

Both the pneumatic and non-pneumatic nozzles suitable for creating droplets of various sizes are well documented in the literature, and suitable nozzles of each type are readily available commercially. One of the common uses of nozzles is to spray droplets of herbicides, insecticides, and fungicides. Nozzles are available commercially to create a distribution of droplet diameters around a predetermined nominal diameter. Commercially available nozzles can create droplets having a nominal diameter as low as about 5 mm, and as high as a nominal diameter of about 1,000 mm, as well as intermediate diameters.

The shape of the spray from a nozzle also depends on the nozzle selected. Preferably, a nozzle having a spray in the form of full cone is used for the invention. Generally, a pressure of about 30 psi to about 40 psi is used to create the spray of droplets. The estimated pressure to be used also depends on the pressure in the space outside the nozzle. That is, if the spray is into a relatively closed environment under some pressure greater than atmospheric pressure, then the pressure applied to the nozzle would need to be increased so that the differential pressure between the applied pressure and the pressure in the container is sufficient to reach the desired pressure for producing the preferred range of diameters of droplets. More than one nozzle can be used at one time, if desired.

It may be desirable to measure the size of the diameters of the droplets produced by a selected nozzle to confirm that the droplets are in a preferred range of diameters. Such measurements are described in the public literature. One such publication is, “Measurement of Droplet Size in Sprinkler Sprays”, U.S. Department of Commerce, NB SIR 88-3715, Jul. 14, 1988.

The droplets of salt water are sprayed into a vertical conduit. The vertical conduit has a heated air stream enabling the droplets to rise up and to be suspended in the air stream. Preferably, the air stream has a temperature of about 180° F. The vertical conduit is designed to create a gradient of air speeds ranging from a relatively high rate near the bottom of the vertical conduit and a relatively low rate near the top of the vertical conduit. The gradient in air speed enables larger droplets to be suspended by the strong upward draft near the bottom of the vertical conduit and for a short time, to be in equilibrium. Because these larger are suspended, the air moving past the droplets and thereby, enhance the evaporation rate of these droplets. As the larger droplets evaporate, and become smaller, the droplets are pushed up to a new equilibrium point higher up in the vertical conduit. During this process of moving from an equilibrium point low down in the vertical conduit to a higher equilibrium point, hot air is passing the droplets and enhancing the evaporation.

One simple method to achieve a desired gradient of air speed is to construct the vertical conduit to increase its cross section in a vertical direction.

The ideal mathematical relationship for the change in air speed and cross-section is as follows:

A₁V₁=A₂V₂ (1)
A₁ is the cross-sectional area at position 1
V₁ is the velocity of the air stream at position 1
A₂ is the cross-sectional area at position 2
V₂ is the velocity of the air stream at position 2
   Formulas (1) can be used to made estimates for the construction of the vertical conduit.

The vertical rate of the air stream could also be slowed by the use of objects built into the vertical chamber to interfere with the air stream to slow the rate down. For example, horizontal rods would interfere with the air stream and slow it down. The number of rods and their placements would need to be determined experimentally. At the temperature being used, it is unlikely that there would be any condensation of the droplets or water vapor on the rods. The rods could be heated internally to further inhibit condensation on the rods. The choice of material for the rods may be important for inhibiting condensation on the rods. Metal rods are preferable.

It is preferable to provide a heating system to heat the air stream going into the vertical conduit to a temperature of about 180° F. to induce a relatively rapid evaporation of the droplets in the vertical conduit, and inhibit condensation within the vertical conduit.

The droplets will be suspended at different levels in the vertical conduit due to the variation of the sizes of the droplets and the variation of the vertical rate of the air stream. The largest droplets require a relatively high rate of air speed and the smallest droplets require much lower air rates. Hence, the largest droplets will be at the bottom of the vertical conduit where the highest rate of the air stream is needed to suspend the largest droplets in equilibrium. As large droplets evaporate into smaller droplets, the air stream will move the droplet up and away from the faster air stream to a new equilibrium state higher up in the vertical conduit.

Initial calculations can be made to estimate the rate of the air stream needed for the largest droplets being introduced into the vertical conduit.

An estimate of the velocity of the air stream to suspend a droplet can be determined using the formula for the force needed to lift a sphere in an air stream:

F=½p v²c_{d}A (2)

F is the drag force

c_{d} is the coefficient of drag for the sphere, independent of size or material

p is the density of the air, approximately 1.225 kg/m³ at sea level

v is the wind velocity, to be solved for

A is the cross-sectional area of the sphere with radius r, A=πr²

### Also,

F=m×g, where g=gravity (3)

v=[(2×mg)/(p×c_{d}×A)]^{1/2} (4)

The air stream rate below the spraying means should be at a rate that generally keeps the larger droplets suspended in place or to move up slowly so that the air stream passing the larger droplets enhances the evaporation of the droplets. It is preferable to have the rate of the air stream near the top of the first conduit generally suspending the very small droplets reaching the top to allow these droplets to evaporate so that the water vapor mixed with salt particles reaching the next stage of the system is preferably free of droplets.

The vertical conduit is connected to a cyclone separator. It may be desirable to insert a filter between the vertical conduit and the cyclone separator to collect at least some of the salt particles, and delay any tiny droplets to allow the tiny droplets additional time to evaporate.

A cyclone separator is a well-known device for separating solids from a mixture of solids and gases. Cyclone separators are available commercially. A cyclone separator is used here to separate the salt particles from the water vapor and it is likely that any remaining tiny droplets will also be separated. It is likely that the remaining tiny droplets contain negligible amounts of salt, and would not have a serious impact on the potable water produced by the invention.

A preferable cyclone separator is the type that can operate continuously without interruptions, and preferable has no moving parts. The cyclone separator is preferably heated to promote the separation process. The heat can be provided by a solar heater, or “waste” heat from another system.

The water vapor from the cyclone separator is moved upward through a final conduit to a condensation chamber. Condensation chambers are well known in the art, and designs for condensation chamber are readily available. The condensation chamber cools the water vapor to liquid water and the liquid water exits to a pipe system for distribution, or a storage tank for use or distribution at a later time.

### SUMMARY OF THE INVENTION

(A) The present invention is a system for desalination, particularly salt water. The desalination system according to the invention, includes a spraying system operable for being connected to a supply of salt water, and operable for the production of droplets of salt water having diameters less than about 500 microns; a vertical conduit for receiving the droplets from the spraying system; the vertical conduit has a cross-section that increases from its lower portion to its upper portion so that the speed of air flow introduced into the lower portion becomes reduced in the upper portion; a fan system coupled to the vertical conduit, and operable for providing a vertical air flow of hot air at the lower portion of the vertical conduit to interact with the droplets to provide a vertical force that can suspend most of the droplets in the air stream, and to push droplets to a higher position vertically as the droplets become smaller;
   a cyclone separator connected to the vertical conduit at the upper portion of the vertical conduit for receiving water vapor, and particles of salt, along with tiny droplets that have not fully evaporated; and a condensing system connected to the cyclone separator for condensing the water vapor from the separator to obtain relatively salt free water.

It is believed that the invention has a recovery percentage, namely the percentage of processed feed water converted into potable water, of more than 90%.

### BRIEF DESCRIPTION OF THE DRAWING

FIG. 1 is a block diagram showing the preferred embodiment of the desalination system according to the present invention.

### DESCRIPTION OF PREFERRED EMBODIMENTS

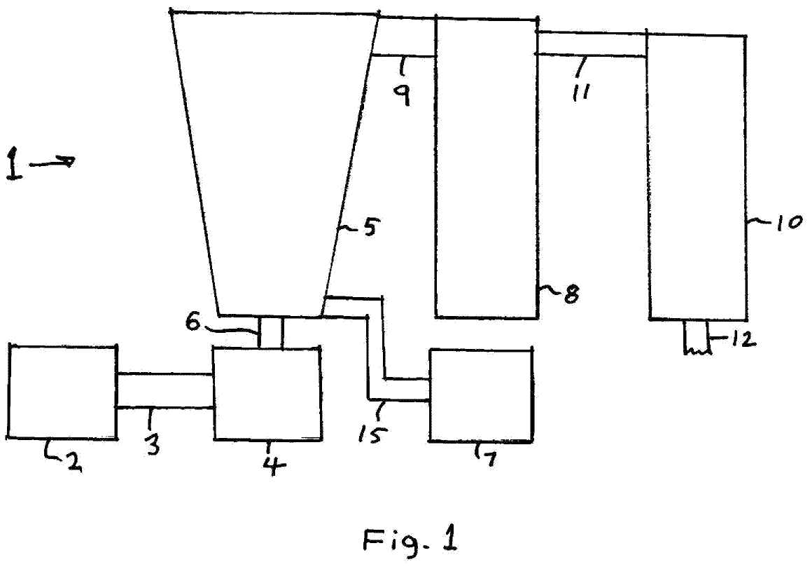

The desalination system 1 according to the invention is shown in FIG. 1 as a block diagram. A supply of salt water 2 can be through a pipe system to a natural source, or a connection to a quantity of salt water transported to the desalination system 1 for processing.

The supply of salt water 2 connected through connection system 3 to spraying system 4. The spraying system 4 is selected to produce a predetermined spraying pattern, and a predetermined range of droplet sizes into the vertical conduit 5 through connection system 6. If desired, spraying system 4 can be arranged to spray directly into the vertical conduit 5.

A fans system 7 is operably connected to the vertical conduit 5 through connection system 15 to provide a hot air stream vertically into the vertical conduit 5 to apply a vertical force to the droplets tend to move droplets vertically.

The vertical conduit 5 has a cross-section that generally transitions from a relatively small cross-section to a relatively large cross-section. The shape of the vertical conduit 5 shown in FIG. 1 suggests a conical shape, but that particular shape is not necessary. The desired shape of the cross-section can be determined experimentally. A conical shape, however, is easy to construct, and may be suitable. It is preferable to have the spraying system 4 produce droplets having diameters less than about 500 microns. A range of droplet diameters less than about 100 microns might be preferable because the evaporation is likely to take much less time than having larger droplets initially.

The specifications for commercially available spraying systems cannot be relied on for precision in the nominal size of droplets produced. Even if a commercially available spraying system is intended by design to produce droplets having diameters less that about 500 microns, it is likely the distribution of diameters will include droplets exceeding 500 microns. Thus, it is necessary to be certain that the combination of the droplets pushed out to the spraying system 4 in combination with the fan system 7 is sufficient to at least suspend all of the droplets produced by the spraying system, but insufficient to blow all or most of the droplets out of the vertical conduit 6 before most of the droplets evaporate.

It is important for almost all of the droplets introduced into the vertical conduit 5 to remain in the vertical conduit 5 long enough for most of the droplets to evaporate. Preferably, all of the droplets introduced into the vertical conduit 5 will evaporate. The desired combination of the range of droplet sizes, vertical air flow, and height of the vertical conduit can be estimated theoretically using know physic formulae, and/or experimentally determined using known methods. Experimental confirmation is preferred.

The water vapor and salt particles remaining from the evaporated droplets are communicated to cyclone separator 8 through connection system 9. It is likely that some tiny droplets of salt water might remain in the vertical conduit 6 and be communicated to the cyclone separator 8. The cyclone separator 8 will separate the salt particles from the water vapor, and it is likely that the tiny droplets will be treated like the salt particles and also be separated. A commercially available cyclone separator is designed in to separate a gaseous state from particles, and it is likely that cyclone operation will differentiate water vapor from tiny droplets and separate the tiny droplets with the salt particles. The few tiny droplets following the water vapor are not likely to seriously impact the resulting potable water.

The water vapor from the cyclone separator 8 is sent to condensing system 10 through connection system 11. Condensing systems are known system commercially available to change the state of the water vapor to liquid water. The water from the condensing system 11 can exit through pipe system 12 for immediate use of for storage.

The objects and advantages of the invention may be realized and attained by means of the instrumentalities and combinations from the foregoing, and are particularly pointed out in the appended claims.

1-3. (canceled)

4. A desalination system comprising:
(A) a spraying system operable for being connected to a supply of salt water, and operable for the production of droplets of salt water having diameters less than about 500 microns;
(B) a vertical conduit; said spraying system positioned in the lower portion of said vertical conduit for creating a vertical stream of said droplets upward in said vertical conduit; said vertical conduit having a cross section increasing from the lower portion of said vertical conduit to the upper portion of said conduit; whereby if an air stream were moving from the lower portion of said vertical conduit to the upper portion of said vertical conduit the speed of the air stream would slow down due to the increasing cross section of said vertical conduit;
(C) a fan system coupled the lower portion of said vertical conduit, and operable for providing a vertical air stream at the lower portion of said vertical conduit to interact with said droplets to provide a vertical force that tends to suspend said droplets in the vertical air stream, and also tends to push droplets to a higher position vertically in said vertical conduit as the droplets become smaller; whereby the interaction of said vertical air stream and said droplets produces water vapor and particles of salt as well as droplets not fully evaporated;
(D) a cyclone separator connected to the upper portion of said vertical conduit for receiving said water vapor, said particles of salt, and said droplets not fully evaporated; and
(E) a condensing system connected to said cyclone separator for condensing said water vapor from said cyclone separator to obtain relatively salt free water; whereby the condensed water can be recovered from said condensing system.

5. The desalination system as claimed in claim 4, wherein said fan system provides air at a temperature of about 180° F.

6. The desalination system as claimed in claim 4, wherein said spraying system provides droplets having a diameter less than about 100 microns.
